(19) United States
(12) Patent Application Publication
(10) Pub. No.: US 2007/0083805 A1
(43) Pub. Date: Apr. 12, 2007

(54) Configurable system and method for order entry

(75) Inventors: Michael Thomas Randazzo, Cary, IL (US); Steven Lawrence Fors, Chicago, IL (US); Nirav Jitendra Shah, Ann Arbor, MI (US); Michael Durst, Philadelphia, PA (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/348,693

(22) Filed: Feb. 7, 2006

Related U.S. Application Data
(60) Provisional application No. 60/726,537, filed on Oct. 14, 2005.
(60) Provisional application No. 60/726,075, filed on Oct. 12, 2005.
(60) Provisional application No. 60/725,761, filed on Oct. 12, 2005.

(51) Int. Cl. G06F 17/00

(52) U.S. Cl. 715/506; 715/505

(57) ABSTRACT

Certain embodiments of the present invention provide for a configurable order entry form. In certain embodiments, the form may be configured by a user. In certain embodiments, the form may mimic a paper form to encourage doctors to use the computer to complete an order form. In certain embodiments, a user may create and/or customize a form. In certain embodiments, a user may specify rules and/or defaults for filling out or completing a form. In certain embodiments, a configurable order form is built in a validation tool. In certain embodiments, a configurable order entry system allows automatic updates of components and/or rules. In certain embodiments, the update of components and/or rules is transparent to a user. Certain embodiments include a component list including a plurality of components and a form configuration tool configured to automatically construct an electronic order entry form using selected components.

### RELATED APPLICATIONS

This application claims the benefit of U.S. Provisional Application No. 60/726,537, filed Oct. 14, 2005, entitled “Configurable System and Method for Order Entry;” U.S. Provisional Application No. 60/726,075, filed Oct. 12, 2005, entitled “Method of Protecting Patient Privacy in CIS Application;” and U.S. Provisional Application No. 60/725,761, filed Oct. 12, 2005, entitled “User-Selectable Low-Bandwidth Logon Option for Web-Based Clinical Information View Application.” The '537, '075 and '761 applications are hereby incorporated by reference herein in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to order entry. More specifically, the present invention relates to configuration of medical order entry forms.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

The Health Insurance Portability and Accountability Act (HIPAA) provides for a variety of requirements for the protection of the privacy of patients. For a variety of reasons, including patient privacy and HIPAA requirements, there is a need for systems and methods to protect patient privacy in medical applications.

Many hospitals and clinics generate electronic medical data in response to examinations and tests. For example, upon performing a battery of tests on a patient's blood sample, a laboratory may generate electronic data to represent the results of the battery of tests. These results can then be reviewed by a physician, radiologist, nurse or other user. These results may be stored in an information system, such as a system described above.

Orders are written by physicians, radiologists, and/or other healthcare practitioners to generate tests, diagnosis, and/or treatment information, for example. However, the current systems and methods for order entry do not permit users to dynamically alter the manner in which order entry options and information are presented to the user. Current systems and methods use hardcoded, fixed forms for the entry of data. These systems and methods do not provide for any configuration capability and do not allow a user to customize an order entry form presenting order options dynamically.

Thus, a need exists for systems and methods that permit users to dynamically alter the manner in which orders are entered. Additionally, a need exists for systems and methods with configuration capability allowing a user to interactively build a form. Such systems and methods can provide for a comprehensive order entry form for patient treatment on a single computer screen. In addition, such systems and methods may provide for the customization of the manner in which orders are entered by a user.

### BRIEF SUMMARY OF THE INVENTION

Certain embodiments of the present invention provide for a configurable order form. In certain embodiments, the form may be configured by a user. In certain embodiments, the form may mimic a paper form to encourage doctors to use the computer to complete an order form. In an embodiment, a user may create and/or customize a form. In certain embodiments, a user may specify rules and/or defaults for filling out or completing a form. In certain embodiments, a configurable order form is built in a validation tool. In certain embodiments, a configurable order entry system allows automatic updates of components and/or rules. In certain embodiments, the update of components and/or rules is transparent to a user.

Certain embodiments provide an electronic order entry configuration system. The system includes a component list including a plurality of components representing at least one of options and queries for an order entry form, where the plurality of components is selectable by a user. The system also includes a form configuration tool configured to automatically construct an electronic order entry form using components from the plurality of components that are selected by the user.

In certain embodiments, the system further includes a rules engine configured to provide a set of rules relating to one or more of the plurality of components, where the rules govern completion of and/or relationship between one or more of the plurality of components. In certain embodiments, the system also includes a forms library including a plurality of order entry forms.

In certain embodiments, the form configuration tool allows a user to save, edit, and/or delete the electronic order entry form, for example. In certain embodiments, the form configuration tool allows a user to save the electronic order entry form by group or by institution. In certain embodiments, the form configuration tool allows a user to specify a default value for one or more of the plurality of components. In certain embodiments, the form configuration tool is accessed via a low bandwidth connection, for example.

Certain embodiments provide a method for creating a configurable order entry form. The method includes providing a set of components to a user, selecting at least one component from the set to add to an order entry form, and positioning the component(s) to create the order entry form.

In certain embodiments, a set of components is provided to a user for a particular institution and/or group, for example. In certain embodiments, at least one component is selected from a listing of components, for example. In certain embodiments, at least one component is graphically selected using a graphical user interface at least one component is graphically positioned using the graphical user interface.

In certain embodiments, the method further includes specifying default values for one or more of the selected components positioned in the order entry form. In certain embodiments, the method also includes establishing relationships between one or more of the selected components positioned in the order entry form. In certain embodiments, the method includes specifying rules for completion of one or more of the selected components positioned in the order entry form.

Certain embodiments provide a computer-readable medium including a set of instructions for execution on a computer. The set of instructions includes a component routine configured to provide a set of components to a user, a selection routine allowing a user to select at least one component from the set of components to create an order entry form, and a form designer routine configured to allow a user to position the at least one selected component within the order entry form.

In certain embodiments, the form designer routine allows the user to specify default values for one or more of the at least one selected component in the order entry form. In certain embodiments, the form designer routine allows the user to define rules related to completion of one or more of the at least one selected component in the order entry form. In certain embodiments, the form designer routine allows the user to define relationships between one or more of the at least one selected component in the order entry form. In certain embodiments, the form designer routine allows the user to designate one or more of the at least one selected component in the order entry form as confidential. In certain embodiments, the form designer routine and the selection routine are manipulated via a low bandwidth connection.

### BRIEF DESCRIPTION OF SEVERAL VIEWS OF THE DRAWINGS

FIG. 1 illustrates an order entry form designer system for configuration of one or more order entry forms in accordance with an embodiment of the present invention.

FIG. 2 illustrates an interface for order entry form generation used in accordance with an embodiment of the present invention.

FIG. 3 illustrates an order entry form generated in accordance with an embodiment of the present invention.

FIG. 4 illustrates a flow diagram for a method for order entry form configuration in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

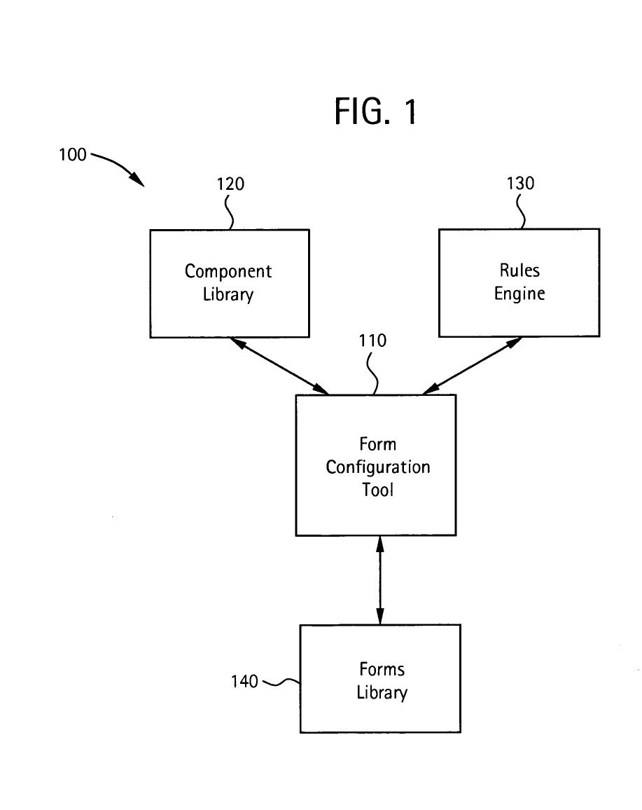

FIG. 1 illustrates an order entry form designer system 100 for configuration of one or more order entry forms in accordance with an embodiment of the present invention. The form designer 100 includes a form configuration tool 110, and a component library 120, for example. In certain embodiments, the designer 100 may also include a rules engine 130 and/or a forms library 140, for example.

In certain embodiments, the form designer 100 allows for the development of components to create an order entry form. The designer 100 relates one or more components to create order entry forms for use by healthcare practitioners. A site administrator and/or a user may create and/or manipulate those components to configure a form for use by, for example, users such as doctors and/or nurses. Components may include one or more of, for example, information, options, fields, icons, tables, check boxes, radio buttons, etc. In certain embodiments, the form configuration tool 110 may be used to select and place components on a screen or other graphical interface to generate a form. Components may be selected, placed and/or otherwise arranged in a form using a point and click device, such as a mousing device, keyboard and/or keypad input, touchscreen input, wheel-based or scrolling input, and/or other interaction. In certain embodiments, one or more templates may be provided defining order entry forms and/or portions of order entry forms, for example. In certain embodiments, components may be added, deleted, and/or modified by an administrator and/or user from the component library 120.

In certain embodiments, a base form may be created. In an embodiment, forms may inherit from a base form. That is, a form may be a variation of another form including one or more of the same components and/or layout. For example, an imaging base order form may be created with specific subsidiary order forms including details for x-ray, ultrasound, and/or other imaging. Features and/or components may be added to an existing form to create another form, for example. The forms may exist in a hierarchy, for example. In certain embodiments, a user may customize, patch, and/or alter a form, for example. A form may include, for example, an urgency (e.g., stat, etc.). In certain embodiments, a user may arrange categories, subcategories, etc., in a form prior to use and/or dynamically during use, for example. In certain embodiments, a user may define relationships between components on a form, for example.

In certain embodiments, the order form configuration tool 110 may be used to set, for example, required fields, default values, default forms, and/or default orders in a form. In certain embodiments, a user may customize defaults. In certain embodiments, a user may restrict fields to certain values. In addition, a user may require a field not to have certain values. The order form configuration tool may store a history of how a form was modified. In certain embodiments, if a form or field is changed and/or updated, historically recorded forms (i.e., forms that were previously generated and used) remain unchanged. For example, if a field is added to a form 2 weeks after Physician A has filled out such a form, Physician A's form remains unchanged. That is, the new field is not added to the historical, saved form. In certain embodiments, a user and/or administrator may be automatically notified if changes and/or updates to a form occur.

Once a form has been configured, a user, such as a doctor, nurse and/or other healthcare practitioner, may then select the form, complete the form, and/or save it. The form may be saved in the forms library 140, for example. In certain embodiments, the order form system 100 may not allow a form to be saved with required fields left unfilled. In certain embodiments, the tool 110 may provide indicators to tell whether a field is required or not. In certain embodiments, the tool 110 may provide indicators to tell whether a field is filled or unfilled. In certain embodiments, a user may drop comments and/or help information on the form, for example.

In certain embodiments, icons may be placed on an order form menu in association with different forms to tell the user at a glance some characteristics of the form. For example, an icon may represent that no co-sign is needed for the form.

In certain embodiments, the order form configuration system 100 is easy to update and allows easy addition and removal of code and components to the order entry framework. The system 100 may also be more flexible for the user. Components in a form may be individual Java classes, for example. Placing a component on a form may instantiate a new class. An architecture of “listeners” may be set up between the components to help the components operate autonomously and interact with other components. For example, this allows components to interact even when it is not known ahead of time which components will be on a form.

In certain embodiments, rules may be established relating components, and/or providing guidelines and/or restrictions, for example. The rules may be implemented using a rules engine 130, for example. The order form design framework 100 may be used to implement standards for, for example, dosage and required fields. These standards may be for compliance with rules, standards, and/or guidelines of, for example, the American Medical Association (AMA), the Food and Drug Administration (FDA), and/or the Joint Commission on the Accreditation of Healthcare Organizations (JCAHO). In certain embodiments, an order entry form may be configured to convert and/or clarify values entered by a user to avoid confusion or satisfy compliance, for example. For example, the order form framework 100 may automatically update software to ensure compliance and/or ensure forms have the current rules and/or tools. Thus, a user may not have to wait for a whole new version to be compliant with new FDA rules, as an example. In certain embodiments, a user and/or administrator may be able to modify rules applied by the rules engine 130 and/or specify applicability of rules and/or types of rules based on type of order entry form, for example.

In an embodiment, a user may fill out an order and specify “save as common”. That is, the order form tool 110 may write the completed order to user's personal list of common orders and/or a set of common order entry forms for a group or facility, for example. A user may select from the list of common orders to use the order on another patient with a single click. Additionally, the system may “learn” a user's defaults. Default values may be specified based on, for example, a user profile. That is, values may be tied to one or more fields for a particular user or type of user. Alternatively or in addition, default values may be specified by a facility, a group, a user and/or a regulation, for example. Orders may be stored in the forms library 140. In certain embodiments, forms may be stored in the library 140 in association with a designation for a classification or type of order form, such as a common order, a default order, etc.

In an embodiment, the order form system 100 may also facilitate an indication concept. That is, a form may ask a user why he/she is ordering a certain medication. The user can fill in an answer. The system 100 may link diagnosis to treatment, for example. For example, the system 100 may suggest forms, medications, other treatments based on malady/diagnosis, and/or show history/examples of other treatments. The system 100 may store predefined care plans based on problem, for example. Plans may then be optimized based on, for example, cost.

Certain embodiments of the present invention provide for a configurable order panel (not shown). The configurable order panel may, for example, hover over items and provide related information about the orders. In an embodiment, hovering over an item may also launch a web page, such as, for example, an x-ray image displayed in a browser.

Certain embodiments of the present invention provide for an ordering screen that allows the user to define custom ordering schedules. For example, a user could say every Monday/Wednesday/Friday at 9 am and 12 pm or some recurring schedule. In certain embodiments, a user may configure an order which represents one large order spread out into many smaller orders. For example, tapering/weaning of medication or reducing dosage over time.

In certain embodiments, order entry may include drug interaction checking and dose range checking, for example. In certain embodiments, the system may display data and user response. The user may then, for example, ignore certain ones, modify an order, and/or remove the order. In an embodiment, the user may capture the data and send it to a pharmacist.

In an embodiment, the system provides an order review screen. The order review screen may allow a user to review orders on a patient. The user may be able to configure or define how to review an order. In an embodiment, filters may be used to review an order. For example, filters may include custom filters such as show only medications, only certain medication, only anesthesia medications for patient A, or only chest x-rays. As another example, filters may filter based at least in part on clinical relevance based on the patient.

Certain embodiments provide for order sets. An order set may include a collection of orders around a certain problem, for example. A diabetic order set, for example, may include standard care for a diabetic. Examples of order sets may include pre-heart surgery order sets and post-surgery order sets. Order sets may be configured by, for example, sites and/or users. Order sets allow a single entry to start a patient on a care plan. In certain embodiments, order sets may be configured, grouped, displayed, and/or re-ordered. An order set may be re-ordered if, for example, a patient comes back with the same problem. In certain embodiments, users may view order text, track where orders come from, and group by order sets (e.g., these orders came from admission, these from pre-op, etc.). In certain embodiments, a user may view data across multiple patients and see what physicians ordered from what order sets. A user may determine if everything from an order set was used, which order sets were used, track conformance, track trends/effectiveness, etc., for example. In certain embodiments, a generic order set is provided. A generic order set may provide a collection of antibiotics and/or other parameter(s), and a user is forced to pick one from the list, for example.

Certain embodiments of the present invention provide for a configurable order form. The order form may mimic a paper form, which may encourage doctors or other users to use the computer to complete an order form.

In certain embodiments, order entry form configuration and usage may be monitored. Form usage, patterns of multiple form usage, and/or other data may be tracked for a patient, a group of patients, an ailment or disorder, a user, a group of users, and/or a facility, for example.

Certain embodiments may provide a flexible order entry system, for example. The order entry system uses order entry forms in the forms library 140 to allow users to generate orders. The order entry system may allow a user to write orders for a patient, for example. For example, a user may specify medications to be administered to the patient with the order entry system. As another example, a user may schedule a procedure for a patient using the order entry system. As another example, the order entry system may by capable of allowing a user to review, change, and/or cancel existing orders; configure default rules for specifying an order; provide interaction checking for medications ordered; and/or allow a user to define and/or utilize an order set to issue a collection of orders with one command, for example.

In an embodiment, the order entry system is capable of allowing a patient to be associated with a care provider. That is, a user may specify an association between a patient and a care provider with the order entry system. A user may thus use the order entry component 130 to associate a patient with a care provider while writing other orders with the order entry system, greatly improving workflow without require the user to change applications, screens, tabs, and/or interfaces, for example.

In certain embodiments, patients may be marked as confidential in a variety of ways. For example, a flag may be received from the hospital's HIS system. The flag may come over ADT, for example. The flag may be received from a component of the HIS, for example. As another example, a patient may be marked as confidential in a patient management system.

In an embodiment, when a patient is marked and/or flagged confidential, one or more staff members previously, currently, or subsequently assigned to the patient as, for example, caregivers, are granted access to the patient and/or the patient's data. Individual staff members, or groups of staff members, may be granted access to the patient. These individuals or groups may be granted access based at least in part on role, for example.

In certain embodiments, when a patient is marked as confidential, an alias name or identifier is assigned to the patient. In an embodiment, this name or identifier may be received along with the confidential flag. The name or identifier may be received over, for example, ADT. The name or identifier it may be auto-assigned. The auto-assigned name may come from, for example, a list of alias names that has been setup in the system. As another example, the auto-assigned name or identifier may be generated dynamically.

In certain embodiments, a confidential patient may be displayed in the system 100 using the patient alias instead of their real name. For example, users that have not been granted access to the patient may be shown the patient alias instead of the patient's real name. In addition, in an embodiment, only staff that have been granted access to the patient may open the patient's medical record. Order entry information may be provided according to patient alias and/or other identifier instead of or in addition to patient name, for example.

In certain embodiments, when a patient has been marked confidential, the system may also control whether, for example, printing and/or reporting on this patient should use the patient's legal name or the alias or both. In an embodiment, this may be based at least in part on who is trying to print and/or access the record. In certain embodiments, the application may not return confidential patients when searching by, for example, legal name. In an embodiment, the system may allow searching by aliases.

Certain embodiments of the present invention allow a user to indicate to the system that the session with the system should at least in part involve low-bandwidth communication. For example, when a user is connecting to an order entry form configuration application via a slow connection, such as dial-up, he or she may desire a low-bandwidth session. This desire may be communicated to the system by, for example, a low-bandwidth checkbox on a logon page or other access interface. When this option is available at logon, for example, users may have the flexibility at the earliest point to choose which connection-speed strategy will work best for them. As an alternative, certain embodiments provide for specifying a user-selectable connection speed setting at logon. As another alternative, a connection speed may be specified at the system configuration level. Alternatively, the bandwidth available to the user may be determined at least in part automatically and/or based on previously specified preferences or sessions or configurations. In certain embodiments, information regarding the connection speed of the user to the system and/or the user's desire for a low-bandwidth session may result in at least one high-bandwidth application being replaced with a low-bandwidth application and/or adapted to provide low-bandwidth interaction.

In certain embodiments of the present invention, a low-bandwidth indication to the system may result in high-bandwidth features being turned off or replaced with lower-bandwidth alternatives and/or versions. That is, the low-bandwidth option may, for example, allow the user to opt for certain features which require high-bandwidth to function reasonably to be turned off in favor of low-bandwidth alternatives. For example, an Order Entry Applet may be turned off in favor of the low-bandwidth-friendly Order Entry Lite feature.

In an embodiment, under a normal fast-connection (e.g., high-bandwidth) usage, the user may switch between, for example, Order Entry Lite and Order Entry, but in low-bandwidth mode, only Order Entry Lite may be available.

As an example, the Order Entry Applet may require for a high-bandwidth connection to perform adequately. Under normal circumstances, when the user logs in, certain activities may start occurring in the background to initialize the data for the high-bandwidth Order Entry Applet option. These may start to occur even before the user attempts to access Order Entry. This may occur, for example, to give the user reasonable performance when they do access the feature. In an embodiment, with the low-bandwidth option indicated, these background activities may cease to occur, making the system perform more optimally, overall, under low-bandwidth conditions.

In certain embodiments, the system may be put into a low-bandwidth mode at the user level on the logon page using, for example, a low-bandwidth checkbox. In certain embodiments, the system may use a low-bandwidth mode when specified at the system level. In an embodiment, the system may be put into a low-bandwidth mode at later point in the session, after logon. In an embodiment, the low-bandwidth mode may, for example, disable the Order Entry Applet. In an embodiment, when the system is configured to disable the Order Entry Applet (e.g., low-bandwidth is the implied default behavior), then the low-bandwidth option may be omitted from the logon page and the system behaves in low-bandwidth mode by default, with no option to switch to the Order Entry Applet.

The components and/or functionality of system 100 may be implemented alone or in combination in hardware, firmware, and/or as a set of instructions in software, for example. Certain embodiments may be provided as a set of instructions residing on a computer-readable medium, such as a memory, CD, DVD, optical storage, magnetic storage, flash memory, or hard disk, for execution on a general purpose computer or other processing device, such as, for example, a PACS workstation.

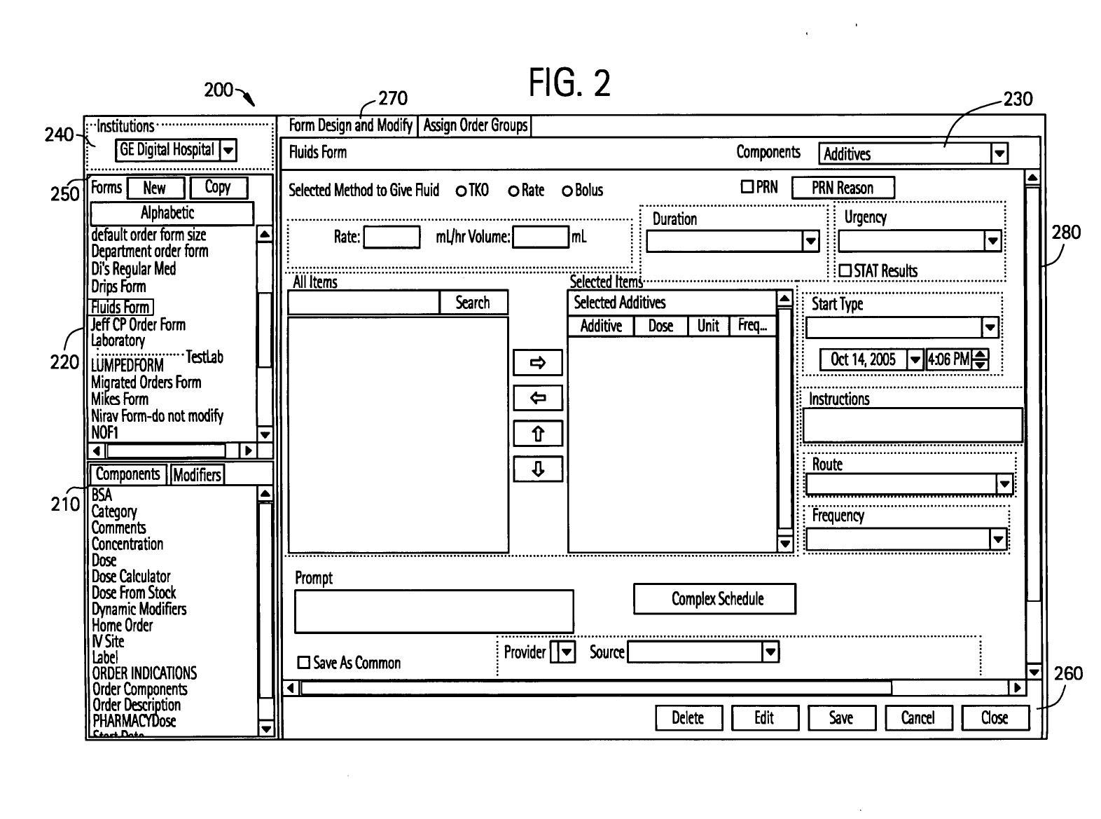

FIG. 2 illustrates an interface 200 for order entry form generation used in accordance with an embodiment of the present invention. The interface 200 includes a plurality of configuration options for a user to create an order entry form. For example, a plurality of components may be selected and positioned on an order entry form. Functionality and/or appearance of components may be configured as well, for example. An order entry form may be selected from a series of templates via the interface 200, and/or a template may be selected and modified to generate an order entry form, for example.

The interface 200 includes a list or menu of components 210, a forms list 220, a components menu 230, a list of institutions 240, form creation options 250, form editing options 260, form design tabs 270, and an order entry form design area 280. In certain embodiments, components may be selected form the components lists 210 and/or 230 for placement in the form design area 280. Components may be modified and/or otherwise configured to have certain properties, parameters, format, appearance, and/or relation to other components and/or entered data, for example. An existing form, form type, and/or template may be loaded from the forms list 220. A form may be selected, copied, and/or created new using the form creation options 250, for example. Forms may be retrieved and/or created for one or more specific institutions using the institutions list 240. A form may be saved, edited, deleted, etc. using the form editing options 260, for example. Form design tabs 270 may allow a user to switch between different options and/or editing screens, such as the form design area 280 and an order grouping or relationship tab, for example. In certain embodiments, one or more icons and/or other indicators may be displayed in conjunction with forms in the forms lists 220 to inform a user at a glance regarding characteristics of the forms (e.g., no co-sign, referral, medication, labs, etc.). Thus, the interface 200 may be used to retrieve, copy, edit, save, transfer, and/or associate one or more order entry forms, for example.

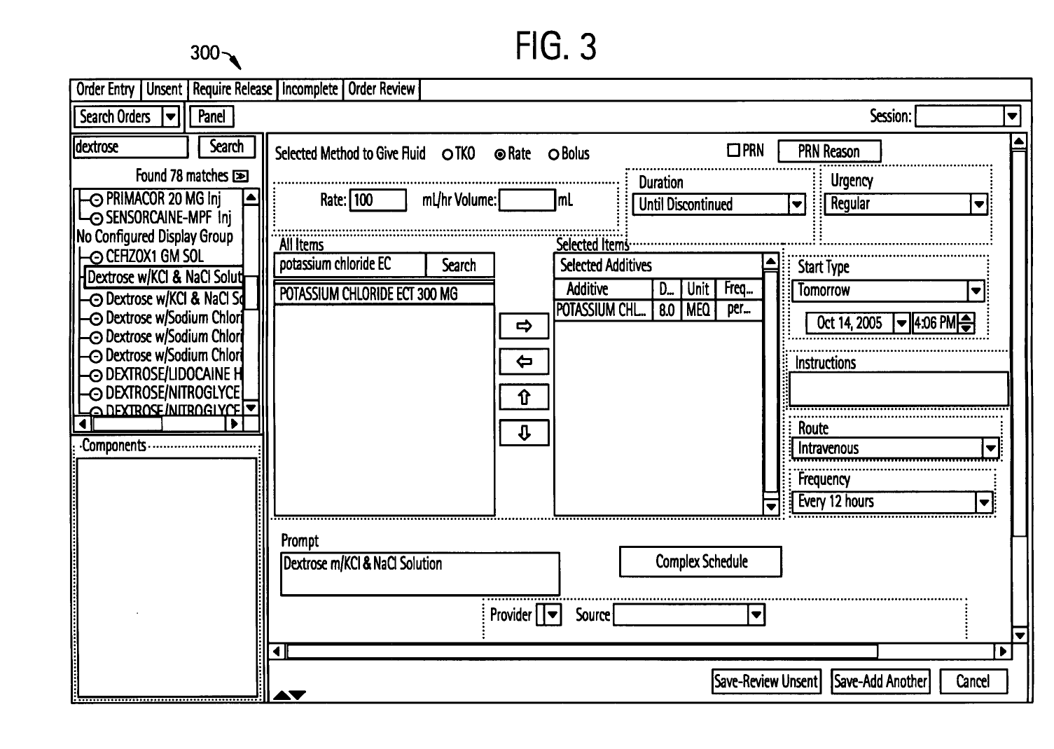

FIG. 3 illustrates an order entry form 300 generated in accordance with an embodiment of the present invention. For example, the order entry form 300 may be generated by the order entry form designer 100 via the interface 200. A user, such as a doctor, nurse, and/or other healthcare practitioner, may use the form 300 to electronically write an order for a patient. Rather than using a traditional paper form, the customized electronic form 300 may facilitate order entry and maintenance of an electronic medical record, for example. In certain embodiments, information entered in the form 300 may automatically be routed to appropriate departments based on form 300 configuration information and/or rules, for example. Using the form 300, orders may be saved, sent, reviewed, and/or modified, for example. Options may be presented in the form 300 for user selection via lists, selection buttons, drop-down lists, and/or completeable fields, as shown in FIG. 3, for example.

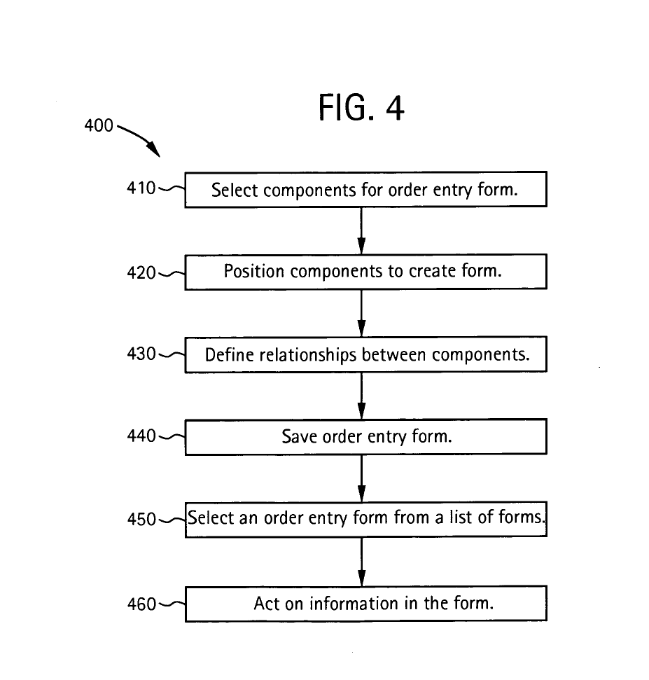

FIG. 4 illustrates a flow diagram for a method 400 for order entry form configuration in accordance with an embodiment of the present invention. First, at step 410, one or more components are selected for inclusion into an order entry form. For example, pull-down menus, selection buttons, entry fields, codes, lists, etc., may be created and/or selected to inclusion in a form. Then, at step 420, the selected components are positioned to create the order entry form. For example, a user may graphically place selected components within a framework to create an order entry form. A user may position components based on traditional paper-based form arrangements, ergonomic considerations, aesthetic considerations, relational considerations, etc. Next, at step 430, relationships between selected components are defined. Relationships may be defined by default rules and/or may be selected and/or specified by a user and/or administrator, for example.

At step 440, the order entry form is saved for later use. Additionally, the form may be created and used. At step 450, a user may select an order entry form from a list of forms. The user may apply the form as is or may modify the form to accommodate a particular situation, for example. Then, at step 460, information entered into the form may be acted upon. For example, information into the order entry form may be stored. Alternatively or in addition, information entered into the form may be electronically routed for execution of the entered order(s), for example. For example, a pharmaceutical order may be routed to a pharmacy to fill the prescription.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electronic order entry configuration system, the system comprising:
a component list including a plurality of components representing at least one of options and queries for an order entry form, the plurality of components selectable by a user; and
a form configuration tool configured to automatically construct an electronic order entry form using components from the plurality of components that are selected by the user.

2. The system of claim 1, further comprising a rules engine configured to provide a set of rules relating to one or more of the plurality of components, the rules governing at least one of completion of and relationship between one or more of the plurality of components.

3. The system of claim 1, further comprising a forms library including a plurality of order entry forms.

4. The system of claim 1, wherein the form configuration tool allows a user to at least one of save, edit, and delete the electronic order entry form.

5. The system of claim 4, wherein the form configuration tool allows a user to save the electronic order entry form by group or by institution.

6. The system of claim 1, wherein the form configuration tool allows a user to specify a default value for one or more of the plurality of components.

7. The system of claim 1, wherein the component list is automatically updated.

8. A method for creating a configurable order entry form, the method including:
providing a set of components to a user;
selecting at least one component from the set to add to an order entry form; and
positioning the at least one component to create the order entry form.

9. The method of claim 8, wherein the step of providing further comprising providing a set of components to a user for at least one of a particular institution and group.

10. The method of claim 8, wherein the step of selecting further comprises selecting at least one component from a listing of components.

11. The method of claim 8, wherein the step of selecting further comprises graphically selecting at least one component using a graphical user interface and wherein the step of positioning further comprises graphically positioning the at least one component using the graphical user interface.

12. The method of claim 8, further comprising specifying default values for one or more of the selected components positioned in the order entry form.

13. The method of claim 8, further comprising establishing relationships between one or more of the selected components positioned in the order entry form.

14. The method of claim 8, further comprising specifying rules for completion of one or more of the selected components positioned in the order entry form.

15. A computer-readable medium including a set of instructions for execution on a computer, the set of instructions comprising:
a component routine configured to provide a set of components to a user;
a selection routine allowing a user to select at least one component from the set of components to create an order entry form; and
a form designer routine configured to allow a user to position the at least one selected component within the order entry form.

16. The set of instructions of claim 15, wherein the form designer routine allows the user to specify default values for one or more of the at least one selected component in the order entry form.

17. The set of instructions of claim 15, wherein the form designer routine allows the user to define rules related to completion of one or more of the at least one selected component in the order entry form.

18. The set of instructions of claim 15, wherein the form designer routine allows the user to define relationships between one or more of the at least one selected component in the order entry form.

19. The set of instructions of claim 15, wherein the form designer routine allows the user to designate one or more of the at least one selected component in the order entry form as confidential.

20. The set of instructions of claim 15, wherein the form designer routine and the selection routine are manipulated via a low bandwidth connection.
